(19) United States
(12) Patent Application Publication
(10) Pub. No.: US 2010/0196632 A1
(43) Pub. Date: Aug. 5, 2010

(54) Thin Wall Plastic Container and Method for Forming Same

(76) Inventor: Raymond C. Eble, Sugarloaf, PA (US)

Correspondence Address: LEWIS, RICE & FINGERSH, LC;ATTN: BOX IP DEPT., 600 Washington Ave., Suite 2500, ST LOUIS, MO, 63101, US

(21) Appl. No.: 12/697,904

(22) Filed: Feb. 1, 2010

Related U.S. Application Data
(60) Provisional application No. 61/149,257, filed on Feb. 2, 2009.

(51) Int. Cl. B29D 22/00; B29C 49/68; B29C 49/64

(52) U.S. Cl. 428/34.1; 425/526; 264/521

(57) ABSTRACT

A conditioning station for conditioning a blow mold preform which includes a heating element for the base of the preform. The conditioning section may also include other heating elements for heating a variety of locations of the preform. The elements are generally arranged so that at least one heat ring is arranged below the preform. The lower preform will generally have a reduced diameter compared to the circumference of the preform. There can also be an element in a moveable position which can adjust position about the side walls of the preform.

### CROSS REFERENCE TO RELATED APPLICATION(S)

This application claims the benefit of U.S. Provisional Patent Application Ser. No. 61/149,257 filed Feb. 2, 2009, the entire disclosure of which is herein incorporated by reference.

### BACKGROUND OF THE INVENTION

1. Field of the Invention

This disclosure relates to the field of blow molding and specifically the blow molding of plastic containers wherein the container preform is conditioned by a heating element so as to produce plastic containers which are constructed with thinner walls and utilize reduced amounts of plastic.

2. Description of Related Art

Containers are ubiquitous for the sale of goods in society. The sale of many products such as liquids or products packed in liquid is essentially impossible without containers in which to transport the products. While the concept of bulk products (where a user supplies his or her own container which is filled from a larger container or a processing machine) is popular for some items due to the end consumer's ability to save money on the product by not having to pay for the container it is packed in and the ability of producers to ship products less expensively since they don't have to ship containers, most items in today's society are prepackaged in disposable containers prior to sale. In this way, a consumer can simply grab a single container of product for easy transport, purchase, and storage. It also provides the product in a fixed, generally popular, size. Further, multiple products, so long as they are shelf stable, can be maintained in inventory or storage.

While the container in which items are sold is often of relatively little import to the end consumer (being simply a means to an end) the design of a container can have a large effect on the manufacture of the product and that will, in the end, alter the presentation of the good and influence the consumer. For a manufacturer, performance of the container under certain conditions allows for the product to be provided to the consumer easier or less expensively which can have a dramatic effect on both profitability of the manufacturer and resultant retail price of the product which can improve sales. Improving the container can therefore result in increases to the manufacturers' profitability. Similarly, attractive containers can provide for improved shelf presentation.

In the first instance, a manufacturer cares about the weight of a container. While heavier containers such as rigid glass containers are generally seen as being stronger and more resilient, heavier containers cost more to construct, as they require more raw ingredients, and, due to the increased weight, also cost more to transport both to the packaging plant, and (once filled) to the end consumers. This creates increased fuel cost, as well as potentially decreasing the maximum load that can be placed in a truck further increasing logistics costs.

Today's society is also placing an increased value on conservation. While most containers can be recycled when the consumer is finished with them, it is always desirable to not expend the resources making an unnecessary container (or making a container overly strong) instead of making and recycling it. Therefore, containers are in demand which conserve raw materials by using less material in their construction and that conserve fuel by improving transportation efficiency both to save on manufacturing costs, and that preserve natural resources.

Soft energy conservation schemes where the type of energy used is not altered but its use is made more efficient can provide for simple steps which benefit the environment but also result in a direct cost savings. Similarly, where a container is intended to be disposed of (recycled) after the product it carries is consumed, making the container “just good enough” to meet its transportation and storage purposes helps preserve resources in the first instance. The cost of transportation has also had significantly increased interest recently due to recognition that even the most efficient production practices can be foiled by significant transportation losses.

Further, it is desired that containers be relatively easily recycled to make new containers. Since containers often hold little value after the product they held has been consumed, it is not desirable to build them to be rugged and sturdy, but just sturdy enough to meet their intended purpose. For all these reasons, containers are striving to get lighter and stronger, specifically, there is interest in using less material to make containers that still can meet performance necessities for shipping, filling, and storage.

As much as conservation is desirable, and use of less material can be beneficial to everyone involved in the container process, containers still need to meet basic design qualifications in order to be useable for a desired task or else they are useless. In a number of containers, it is important that a container have sufficient integrity to be able to avoid collapsing while being filled, and to support and maintain shape throughout transport and during sale. In addition to making the container have sufficient integrity, it is also desirable that the container be easy for the manufacturer to use and have a desirable appearance for marketing purposes. Modern high-speed manufacturing processes are often more reliant on through-put for cost savings and, therefore, cheaper containers, if harder to use, may actually result in a net cost increase because they are not useable in certain manufacturing processes.

Often the requirements of manufacture mean the container cannot utilize design components which could alter the outer surface of the container as that may make it more difficult to apply labels or to have the container handled by automated packing and handling machines. While designs of containers exist which provide for lighter weight by providing for improved structural features, such as those described in U.S. patent application Ser. No. 12/052,177, the entire disclosure of which is herein incorporated by reference, in certain applications containers which use such structural features are simply unusable. In still further applications, manufacturers of products will be reluctant to use such containers as the structural features may interfere with brand marketing programs related to more traditional container shapes. Therefore, it is desirable to develop containers utilizing more traditional shapes, sizes, and construction methods while still reducing the amount of material used in their construction.

### SUMMARY OF THE INVENTION

Because of these and other problems in the art, discussed herein is a plastic container, and a method for forming a plastic container, which utilizes a reduced gram weight of material in blow molding while still maintaining an equivalent strength. Such containers are formed utilizing a preform heating methodology which utilizes a heating element heating a container mold preform in a conditioning unit prior to the preform being provided to a blow station. Generally, the preform will be heated from below so as to allow for heating of the base of the preform.

There is described herein, among other things, a conditioning unit for conditioning a stretch blow molding preform, the unit comprising: a chamber enclosing a preform, the preform having a main body portion with a circumference and a base portion; and a heating element, the heating element being positioned in the chamber below the base portion of the preform so as to heat the base portion of the preform.

In an embodiment of the unit the heating element is in the shape of a ring which may comprise a toroid and/or may have an inner circumference smaller than the circumference of the main body portion of the preform.

In another embodiment, the unit further comprises a second heating element, the second heating element having a moveable position. The element may be fixed in position prior to placing the preform in the chamber or may move while the preform is in the chamber. The element may also be controlled independently of the heating ring element located below the base portion.

The second heating element may also comprise a ring which may be a toroid and/or may have an inner circumference greater than the inner circumference of the heating element ring located below the base portion.

In another embodiment of the unit, the preform includes a transition section and the conditioning unit further comprises a heating ring element surrounding the transition section.

In another embodiment, any or all of the heating elements emits infrared radiation.

There is also described herein, a conditioning unit for conditioning a stretch blow molding preform, the unit comprising: a chamber enclosing a preform, the preform including: a main body portion; a transition portion above the main body portion; and a base portion below the main body portion; and means for heating the base portion.

In an embodiment, the unit further comprises means for heating the main body portion and/or means for heating the transition portion.

In an embodiment, all the means for heating emit infrared radiation and/or all the means are independently controlled.

There is also described herein a method for producing a plastic container, the method comprising: forming a preform; conditioning the preform by heating a base of the preform to inhibit cooling of the base of the preform; and blow molding the conditioned preform into a container.

There is also described a container produced by the above method.

### BRIEF DESCRIPTION OF THE DRAWINGS

FIG. 1 provides a side view of a reduced gram weight container.

FIG. 2 provides a top view of a reduced gram weight container.

FIG. 3 provides a bottom view of a reduced gram weight container.

FIG. 4 provides a side view of a four chamber conditioning station.

FIG. 5 provides a partial sectional view of an embodiment of a chamber of a conditioning station including a lower heating ring for use on a container preform.

FIG. 6 provides a partial sectional view of another embodiment of a chamber of a conditioning station including a lower heating ring and an adjustable ring therebetween.

### DESCRIPTION OF THE PREFERRED EMBODIMENT(S)

Because of the various competing desires in packaging, a large number of products are changing from being packaged in glass or metal to being packaged in plastics. Plastics are generally lighter than alternatives, often more resilient, and can be recycled. There are also a wide variety of plastics available which can be selected depending on the products sold in the container. The most common type of plastic containers are probably polyethylene terephthalate (PET) containers which can be blow-molded and can provide for a clear finish which resembles glass. PET containers also often use less material than those made of other plastics due to the nature of their construction.

Plastic containers as a whole are usually significantly thinner than similar glass containers and recent improvements in technology have allowed them to become even thinner while still retaining resilience. In blow molded containers, however, the blow molding process can still result in containers having more material than is necessary.

Specifically, in blow-molding processes and specifically injection stretch blow molding (ISBM), it is generally the case that plastic is first formed into a preform or parison. This is a structure which provides for a loose shape and will be in a semi-molten form. The preform is generally formed via a typical injection molding process in the first station of the ISBM process. The preforms are designed to have a neck finish at one end whose geometry is determined by the ultimate use of the container and closure type. The diameter of the neck can range from about 33 to about 160 mm. The preform will be conditioned (as discussed below) and then is sent to the final station where pressurized air is introduced into the preform. The preform is stretched with what is commonly called a “core rod” as part of the process. A container of the desired shape is formed in what is commonly called blow molds.

In ISBM, during the blowing of the container, it is stretched in both the hoop (transverse) and axial directions. The stretching of PET results in strain hardening of the resin, allowing the finished containers to resist deformation under internal pressure in subsequent use. When the blowing process has been completed the formed container is transferred to an Eject Station where it is removed from the machine via various methods.

One of the major advantages of ISBM is the ability to stretch the preform in both the hoop direction and the axial direction. This biaxial stretching of material increases the tensile strength, barrier properties, drop impact, clarity, and top load in the container. This makes it possible to reduce the overall weight in a container by 10 to 15 percent less when compared to other methods of producing a container.

One of the facets of the preform is that when the preform shape is compared to the resultant blow shape, different thicknesses of material in the preform can be used to form different parts of the container at different thicknesses. Components of the container which do not require as much structural resilience (e.g., walls) can be made thinner than components (such as transition points) which have to be stronger to preserve the container's structural integrity.

In traditional ISBM, however, it was generally technically difficult to have different parts of a container have different thicknesses when the container is blow-molded as a single monolithic component. In the first instance, having different thicknesses required a specifically shaped mold preform, which could be difficult to produce. While this problem could often be overcome, one of the bigger problems was that a design with parts which were significantly thinner than other parts could cool unevenly in the preform. Such uneven cooling could result in a container which was not correctly blown, or which had unsightly or even structurally deficient areas. If the container preform, for example, includes a thinner side wall so that the resultant container will have thinner walls, the walls of the preform can cool quicker than other components (since less material retains less heat). Thus, the thinner sections of the preform may not blow correctly.

The more distorted different sections of the preform are in thickness, the more severe the uneven cooling can become. To avoid this situation in the past, the portions of the preform which correspond to structural elements are made the necessary thickness and then the remaining components are made sufficiently thick to insure that uneven cooling does not effect the blow molding process. Thus, some components are made thicker than necessary to provide structural integrity to improve blow-molding performance.

Not only does the cooling of the mold preform result in more material than may be strictly necessary having to be used in the container, it can also slow down the molding machine since the resultant container will generally take longer to cool once it is formed. Specifically, the inclusion of additional material to retain heat in the preform also results in the container taking longer to cool once blown, meaning that containers may take longer to make than is strictly necessary.

Thus, the manufacturer has been trapped in a catch-22. Using thicker material provides for improved molding characteristics and container predictability, but does so by increasing cost and reducing manufacturing speed. To deal with this inherent conflict, described herein is a mold conditioning station which includes a plurality of conditioning chambers. Each chamber utilizes a lower heat source, and may utilize a plurality of heat sources, to provide heat to specific portions of a mold preform that are desired to be thinner than others. The heat sources maintain the plastic preform in a flowable state and prevent premature cooling, and can also be used to provide for the movement of plastic in the preform to form a preform of desired characteristics. Namely, the heating allows for material to be moved from areas which do not need to be as strong to areas that do. In effect, this allows a greater gradient between thin and thick portions of the container. This conditioning station can then be used to produce a container utilizing a reduced amount of raw materials while still maintaining the container's integrity and manufacturing speed.

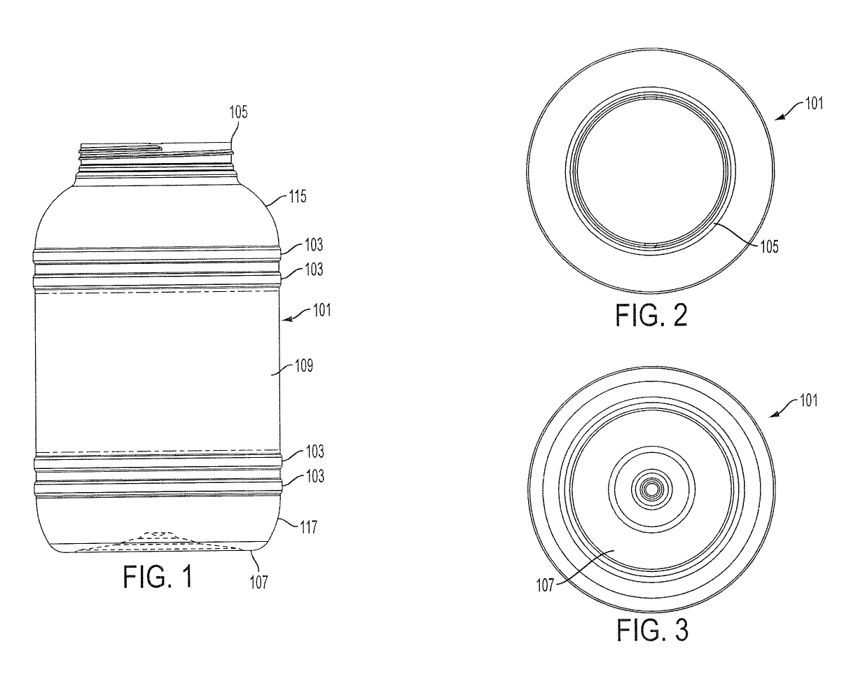

In an embodiment, a container produced in accordance with the current disclosure comprises a standard plastic container which is constructed by blow molding and specifically ISBM but uses a reduced gram weight of material in its construction compared to standard construction techniques being used to make a container of equivalent shape and size. While this disclosure will focus on PET containers, various thermoplastic materials such as, but not limited to, acrylnitrile (AN), polystyrene (PS), Polyvinyl chloride (PVC), polyamide (PA), polycarbonate (PC), Polysulfone, acetal, polyarlyate, polypropylene (PP), surlyn, and polyethylene terephthalate (PET) can be used in the present blow-molding methods and machines and formed into the resultant containers. In an embodiment, the weight is selected to be one where, utilizing a traditional blow molding apparatus of the prior art, at least a portion of the preform would cool too quickly to allow for the container to be blown. For example, in a gallon container the gram weight of the material is preferably less than 100 grams and more preferably less than 95 grams. Further, it is generally preferred that the container utilize a shape and size of known type and design. That is, the container would generally appear identical to an existing container, but would include at least some thinner walls and thus reduced gram weight over the traditional container which would have walls of generally uniform thickness. This modification would also generally not alter the container in a structural fashion which relates to its integrity in any expected use. Thus, the container is in effect, simply a lighter version of a pre-existing container. One embodiment of such a container (101) is shown in FIGS. 1-3

The container (101) generally does not provide for substantial structure designed to improve rigidity over a similar container and preferably utilizes a more basic design or the same design as a container made using an increased gram weight of material. Thus, the container (101) generally lacks structural features designed to increase its integrity or strength and includes a number of smooth surfaces including the top (115) and bottom (117) cuffs and the label area (109). However, it should be recognized that in alternative embodiments, containers utilizing such structural features can be produced in the same fashion to also control their weight.

In container (101) therein are included multiple bands (103) generally toward the top (105) and the bottom (107) cuffs which can reinforce the hoop strength of the container (101). However this is not strictly necessary. In container (101), there are no generally structural elements found in the traditional label area (109) and the surface is substantially smooth. Structures in this area, while they can be used to greatly improve strength (as is shown in, for example, U.S. patent application Ser. No. 12/052,177 incorporated above) can be a problem for certain types of labeling machines or can simply be undesirable from an aesthetic point of view.

Further, the top (115) and bottom cuffs (117) of the container (1010 are also relatively simple and also show plain lines instead of structural features. Again, while structural features in this area can improve the strength of the resultant container (101), they often provide the container (101) with a specific look and require surfaces not to be smooth. Again, U.S. patent application Ser. No. 12/052,177 provides an example of structural features incorporated into the cuffs (115) and (117). To further improve weight characteristics, the bottom (107) of container (101) is generally thinner than traditional designs of similar shape and size as the bottom generally provides little structural support for the container (101).

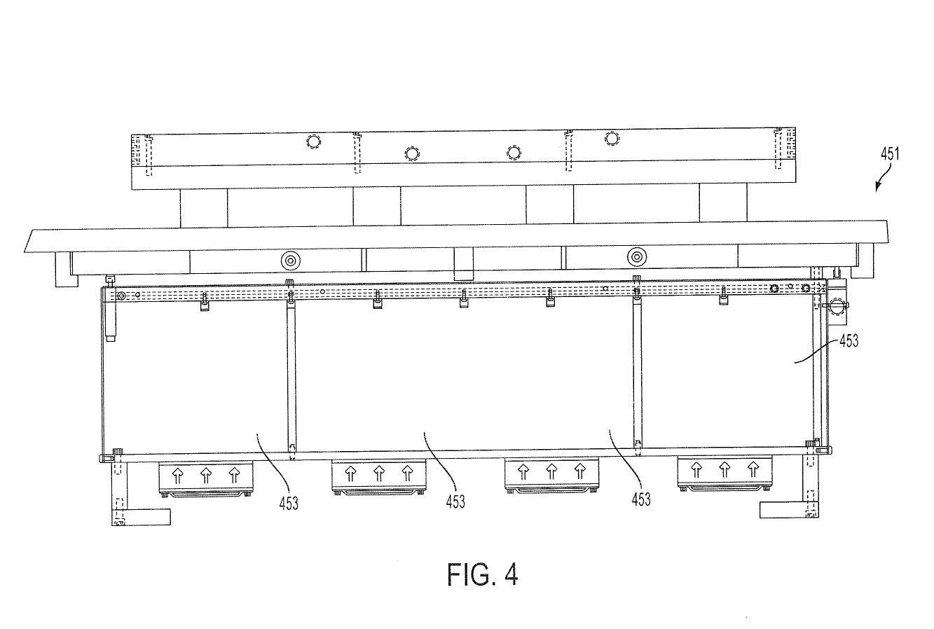

Formation of the container (101) generally utilizes a system which conditions a preform (401) to provide for more even heating and reheating of the preform (401) prior to it being blown into the mold. An embodiment of a conditioning unit (451) which may be used to condition the preform (401) is shown in FIG. 4. The conditioning unit (451) will generally include a plurality of chambers (453) each of which will house a preform (401) immediately prior to it being placed into the blow station (which will generally be immediately below the conditioning unit (451)) and blown in to the final desired shape. As contemplated above, the conditioning unit (451) will generally be located between the injection station forming the preform and the blow molds themselves where the preform is formed into the container.

Each chamber (453) will utilize a plurality of heating elements to provide for heating of the preform (401) in precise locations. The systems and methods discussed herein preferably utilize infrared heating lamps in a ring or toroid form as the heating elements. In alternative embodiments and depending on the shape of the preform, elliptical rings, spherical rings, or other even square or other rings can be used as the rings. The heating rings, in an embodiment, comprise Quartz Tungsten Infrared heating lamps such as those produced by Ceramicx Ireland, Ltd.

The chambers are appropriately cooled and shielded to provide directed heat. In an embodiment, heat is produced by the rings producing infrared radiation. United States Patent Application Publication 2008/0220114 A1, the entire disclosure of which is herein incorporated by reference, provides for a system which utilizes a single such heating ring positioned to surround the transition region of the preform (401). While the system of that application provides for some control over the heating of the preform (401), the system is limited to providing for control at fixed points in the transition region of the container and is designed to eliminate the presence of a choke in the resultant container. It is not designed to provide for a reduced gram weight container.

In the conditioning station (451) of FIG. 4, similar heating rings and related cooling and shielding mechanisms may be used as contemplated in the above referenced patent application publication 2008/0220114 to assist in forming the transition region. However, in the present conditioning station (451) a heating element is used in order to provide that containers of reduced gram weight can be produced. The embodiments provided herein allow for increased control as well as movement of material from different points in the preform (401). Specifically, the present conditioning station allows for the bottom (107) of the container to be thinner than has been traditional and the second embodiment provides that portions of the label area (109), ribs (103) or cuffs (115) or (117) may include a variable thickness at different points. The system can also be used to manipulate plastic within the preform to provide for containers of more complex geometry and reduced weight.

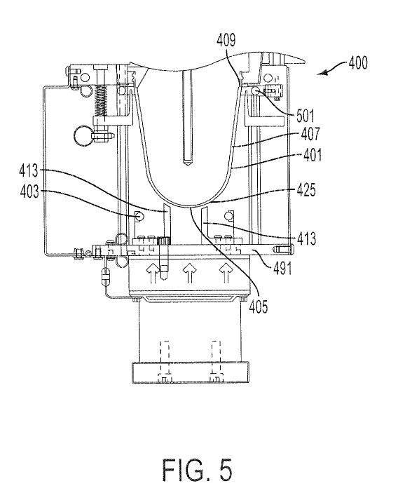

An embodiment of the interior (400) of the chamber (453) and an associated preform (401) is shown in FIG. 5. In this embodiment, a heating lamp (501) is provided in an upper position, focused at the transition portion (409) such as that described in US Application 2008/0220114 A1. In this embodiment, this lamp (501) is used in conjunction with an additional lower lamp assembly (403) which is specifically designed to heat the bottom portion (425) of the preform (401) and is positioned toward the bottom (491) of the chamber (400). In FIG. 5, the lower lamp assembly (403) is provided as a part of each of the chambers (453) in the conditioning station (451). The lamp (403) is used to heat the bottom (425) of the preform (401). By heating the bottom (425) of the preform (401), this area, which is generally the coldest, is allowed to be thinner as the base (425) will not cool prematurely and prevent molding prior to being blown into the mold.

The inclusion of upper lamp (501) on the transition portion (409) can be preferred in certain embodiments but is by no means necessary. In an alternative embodiment, the lower ring (403) can be used alone or in conjunction with the moveable ring (603) (discussed later) without the ring (501) being present.

As shown in FIG. 5, the lower lamp assembly (403) will generally have a diameter less than the diameter of the preform (401) and will be positioned generally below the base (425) of the preform (401). This position allows for heat to be distributed not just to the sides of the base (425) but closer towards the center (405) of the base (425) if that is desired. Due to the nature of the preform (401) handling and pressure to the mold, it will generally not be possible to place the heat source immediately below the center of the base (405). Utilizing a ring structure of reduced diameter for the lower heating element (403) allows the preform (401) to pass from the conditioning unit (450) into the blow mold in the traditional fashion and does not interfere with that process. At the same time, having the ring (403) have a decreased diameter compared to the preform provides that more heat can be directed to the bottom center (405) of the base (425) (and the base (425) generally) than may otherwise be possible.

Further, a ring is generally a preferred shape for the lower heating element (403) as it provides for heating in a multitude of directions. Specifically, the ring (403) can radiate heat into the center of the ring (403), but will also generally radiate heat above the ring and in a concave “arc” surrounding the ring (403). This can place an increased amount of the base (425) within an area of predictable heat and further improve the ability to maintain the preform base (425) in a flowable condition.

Heat may also be focused away from the direct center (405) of the preform. Specifically, as the shape of the bottom (255) of the preform (401) is generally convex toward the base of the chamber (453), the ring shape provides for a loosely cooperative shape. Specifically, the convex portion of the base (405) will generally extend closer to the ring (403) and will generally move more towards the interior of the ring (403) (even though the ring (403) does not surround the point (405)). The heat radiation pattern from the ring (403) will generally result in an arrangement whereby the hottest point is at the center (as more of the ring irradiates that point) and the heat radiation will decrease as one moves up and out from the ring (403). Thus the center (405) of the base (425) of the preform (401), will generally be a similar distance from the surface of the ring (405) as other portions of the base (425). In certain embodiments, this may be a desirable arrangement. In the depiction of FIG. 5, heat is desired to be applied toward the outer convex surfaces of the base (425) but not necessarily at the very center (405). Therefore heat shields (413) are supplied which serve to partially block and direct the heat of the heat ring (403) away from the very center of the base (405) and into the desired portion.

The heating is generally used a part of conditioning in a single-stage blow molding process. There is no need to utilize a two-stage process as the inclusion of the lamp assembly (403) at the lower portion in the conditioning allows for a true reheating of the preform (401) prior to molding. Thus, the conditioning station (451) replaces a traditional conditioning station.

Further, since the bottom (425) of the preform (401) may be heated in conjunction with heating of the rest of the preform (401), the location of plastic in the preform (401), and thus the resultant container (101), can be more precisely controlled. Specifically, material which was often present in the preform (401) to provide for sufficient heat retention and which formed the base (107) of the resultant container is not necessary. The material can thus be redistributed in the resultant container (101) away from the base (107).

The redistribution is particularly useful when it comes to the base (425) of the preform (401) as the base (425) has traditionally been an area where heat retention was more difficult (it being one of the cooler areas of the preform (401)) and thus significant excess material was often required to be present to allow for the preform to be successfully blown. At the same time, the base (107) of a container (101) provides virtually no necessary structural support as the base (107) simply serves, in many respects, to enclose the container (101). Vertical forces on the container (101) are generally supported by the walls while horizontal forces are generally most severe in the center of the container (which is hollow) and are resisted by hoop rings (103). The base (101), being generally a flat disk, needs little additional structural integrity.

It is important to note that the lower heating ring (403) is not necessarily designed to alter the resultant shape of the blown container and the resultant container (101) is intended to be structurally similar to a container blown using the same mold and preform on a system without the lower heating ring (403). The inclusion of the lower heating ring (403) simply allows for the material at the base (425) of the preform (401) to be thinner than has traditionally been possible.

This gram weight reduction can produce a container (101) which has significantly reduced gram weight of material used without necessarily altering the resultant structure strength or the design of the container (101). Since this material can also be redistributed, it is further possible to produce a container (101) with substantially the same gram weight of material as would traditionally be used, but making it stronger than traditional blow molded containers of near identical shape since material can be redistributed within the container (101). By utilizing the redistribution of material, expected failure points in the container (101) can be made thicker, while points where failure is less likely can be made thinner resulting in a stronger container (101) of similar weight. In effect, the gradient between the thinnest portion of the preform (401) and the thickest portion of the preform (401) can be increased while still allowing for a successful blow operation.

Further, utilization of the heating ring structure (501) such as that described in US Application publication 2008/0220114 in conjunction with the lower lamp assembly (403) as shown in FIG. 4 allows for even more precise heat application control. While different embodiments can utilize different shapes, the ring structure allows for heat to be distributed around the preform (401) in a generally equal fashion. This more precisely distributes heat in the preform (401), and thus plastic distribution in the resultant container (101) allows for more precise positioning of material and the ability to construct thin wall designs.

Specifically, the upper lamp (501) can be used to distribute material downward in the preform (401) while the lower lamp (403) can be used to distribute material upward allowing more precise control and allowing for material to be “shifted” away from points where it is not needed during the preform stage. In a preferred embodiment, containers (101) can be constructed which utilize a minimum amount of material to produce a container of desired shape, size, and design.

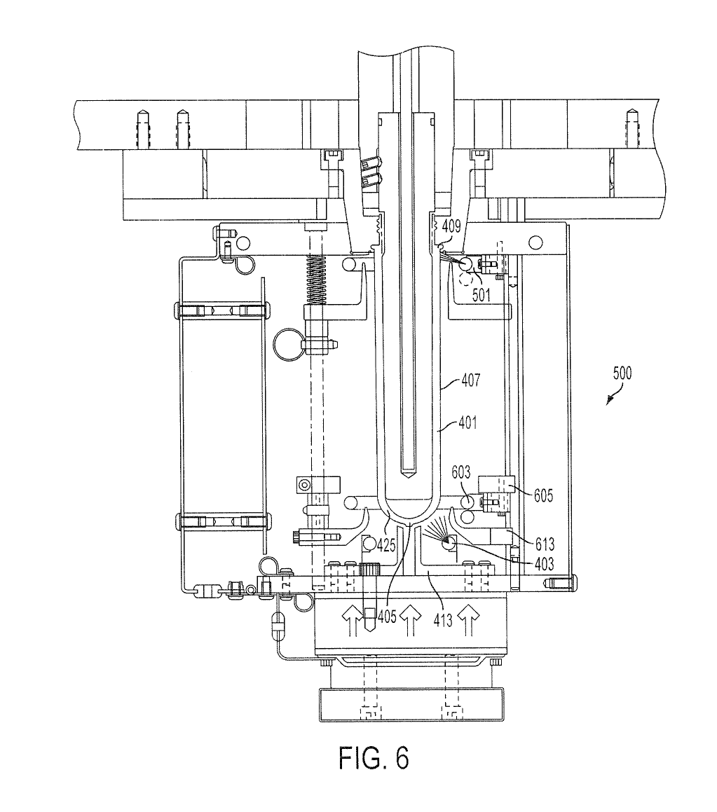

While the inclusion of a base heating ring (403) provides for a number of benefits in the preform (401) heating and container (101) construction, another embodiment of a conditioning chamber (500) discussed herein provides for still further benefits. In particular, in the heating chamber (500) of FIG. 6 the lower heating ring (403) is joined by upper heating rings (501) and (503). The ring (501), as discussed previously, is arranged in the transition region as discussed in US 2008/0220114. As shown in FIG. 5, a lower ring (403) is provided below the bottom (425) of the preform (401) and has a reduced diameter.

The third heating ring (603) is provided in FIG. 6 positioned between the rings (501) and (403). This ring (603) is designed to be moveable so as to provide for control over heating position. To provide for movement the heating ring element (603) is disposed on an adjustable chassis (506) which can allow for adjustment of the heating ring element (603) within the heating chamber (500). The ring (603) can therefore be placed where desired within the chamber (500) to provide for heat adjacent to a chosen thinner section of preform (401) based on the design of the preform and the intended container. In the depicted embodiment of FIG. 6, the ring (603) is positioned toward the bottom (425) of the preform (401) so as to provide increased heating to that portion of the preform. In alternative embodiments, the ring (603) may be positioned anywhere within the main body portion (407) of the preform (401).

Effectively, when a plurality of heating rings are used, the preform (401) may be thought of as having three portions. The transition portion toward the neck of the preform (401), the base portion (425) and the wall or center section (407). Placement of the heating elements will generally be with at least one heating element in each section, but that is by no means required.

It should be noted that the preform (401) of FIG. 6 is differently shaped to be preform (401) of FIG. 5. This is done to illustrate that certain preform shapes may be more desirable for certain conditioning chamber conditions. Specifically, the chamber (400) is often more useful for wider squatter performs while the chamber (500) is often more useful for narrower performs. However, either chamber is useable on either preform (401) and the preforms are essentially interchangeable. Hence, the reuse of reference numbers.

As indicated, the heating ring (603) will generally be positioned on a chassis (605) which will allow it to move between the position of the upper ring (501) and the lower ring (503). Therefore the ring (603) can simply be positioned in a desirable position to provide heat at a specific point or area. In an alternative embodiment, variable heat can be applied across the surface by allowing the ring (603) to move during the heating process and therefore traverse a portion of the preform (401) prior to molding.

The former is generally preferred, as it can provide for more even heating of a larger portion of the wall section (407) of the preform (401). It also allows for heat to be distributed over a larger area. The moveable design during heating may be desirable if different levels of heat are required for adjacent locations or in particularly complex preform (401) designs. In this embodiment the ring (603) can move to provide for greater heat in certain areas and less in others. Still further, the specific pattern of movement could serve to provide increased heat to some areas while other receive additional heat, but at a reduced amount.

In a still further embodiment, the different heat rings (510), (403) and (603) may be independently controlled by a computer or similar automated control device to provide for still further control over the specifics of the heating of the preform (401). Specifically, in an embodiment, a controller may be provided that allows for the precise on/off timing and heat output of each ring (501), (403) and (603) to be independently controlled. In an embodiment, thus, each ring (501), (403) and (603) may provide a different level of intensity, and may provide heat for a different period of time. The system may also provide for the rings (501), (403) and (603) to turn on and off at different times. Thus it is possible to have one lamp activate, turn off and have a second lamp activate. Such serial heat application can provide for still further customization of heat application and therefore additional control over the preform (401).

Having more than one ring allows interaction between the rings. For example: applying an appropriate amount of power to both the upper (501) and lower ring (403) will allow material to be moved toward the center of the container (101) when blown. Applying an appropriate amount of power to the center ring (603) allows material to both move both upward and downward at the same time at it's set position. Using the upper (501) and lower ring (403) together in conjunction with the center ring (603) would allow precise positioning of material above and below the center ring (603) in the preform (401). Appropriately balancing the amount of power to all rings (501), (403), (603) allows smooth transitions of material around the parts of the preform (401). This is particularly useful for producing containers with complex geometry and producing containers with sections of precisely controlled thickness.

As in the embodiment of FIG. 5, the heat of ring (603) can be directed to a narrower portion of the preform (401) through the use of a shield (613). In the depicted embodiment of FIG. 6, the shield (613) is positioned to inhibit the heat rings (403) and (603) from having overlapping heat areas because of their placement in proximity. In alternative embodiments the shield (613) can be moved to direct heat differently as may be desired by the operator. In order to provide for desired shielding in conjunction with the variable placement, depending on embodiment, the shield (613) may be placed on the moveable carriage (605) or may be placed on a separate carriage to provide for independent movement.

In a still further embodiment, the moveable heat ring (603) need not be a singular ring. Multiple rings may be provided forming a set which moves together. In a still further embodiment, multiple separate heat rings that are moveable independently may alternatively or additionally be provided to allow for increased customizability of the heat positioning. In a still further embodiment, the heat rings (501) and (403) can also be placed on a moveable chassis to provide for still further customizability in heat ring placement. An increase in the number of heat rings is particularly desirable where a particularly long preform (401) is used, or if the application of heat is desired to be precise such as if the preform (401) was to have significantly different points of thickness and particularly where such points differ in vertical position.

As should be apparent, the inclusion of multiple moveable heat rings (603) is not limited to two as discussed above. Depending on the length of the preform (401) and the desired amount of control, any number of moveable heat rings (603) can be used. This can provide improved control over long preforms (401) and allow for material shifting over a greater distance.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A conditioning unit for conditioning a stretch blow molding preform, the unit comprising:
a chamber enclosing a preform, said preform having a main body portion with a circumference and a base portion; and
a heating element, said heating element being positioned in said chamber below said base portion of said preform so as to heat the base portion of said preform.

2. The unit of claim 1 wherein said heating element is in the shape of a ring.

3. The unit of claim 2 wherein said ring comprises a toroid.

4. The unit of claim 2 wherein said ring has an inner circumference smaller than said circumference of said main body portion of said preform.

5. The unit of claim 1 further comprising a second heating element, said second heating element having a moveable position.

6. The unit of claim 5 wherein said second heating element is fixed in position prior to placing said preform in said chamber.

7. The unit of claim 5 wherein said second heating element moves while said preform is in said chamber.

8. The unit of claim 5 wherein said second heating element comprises a ring.

9. The unit of claim 8 wherein said ring comprises a toroid.

10. The unit of claim 8 wherein said heating element positioned below said base portion of said preform also comprises a ring.

11. The unit of claim 10 wherein an inner circumference of said heating element ring located below said base portion is less than an inner circumference of said second heating element ring.

12. The unit of claim 5 wherein said second heating element is controlled independently of said heating element positioned below said base portion of said preform.

13. The unit of claim 1 wherein said preform includes a transition section and said conditioning unit further comprises a heating ring element surrounding said transition section.

14. The unit of claim 1 wherein said heating element emits infrared radiation.

15. A conditioning unit for conditioning a stretch blow molding preform, the unit comprising:
a chamber enclosing a preform, said preform including:
a main body portion;
a transition portion above said main body portion; and
a base portion below said main body portion; and
means for heating said base portion.

16. The unit of claim 15 further comprising means for heating said main body portion.

17. The unit of claim 16 further comprising means for heating said transition portion.

18. The unit of claim 17 wherein all said means for heating emit infrared radiation.

19. The unit of claim 17 wherein all said means are independently controlled.

20. A method for producing a plastic container, the method comprising:
forming a preform;
conditioning said preform by heating a base of said preform to inhibit cooling of said base of said preform; and
blow molding said conditioned preform into a container.

21. The container produced by the method of claim 20.
